(19) United States
(12) Patent Application Publication
(10) Pub. No.: US 2020/0117192 A1
(43) Pub. Date: Apr. 16, 2020

(54) Travel Control Device

(71) Applicant: Hitachi Automotive Systems, Ltd., Hitachinaka-shi, Ibaraki (JP)

(72) Inventors: Seiichi SATOH, Hitachinaka-shi (JP); Toshiyuki INNAMI, Hitachinaka-shi (JP); Naoki HIRAGA, Hitachinaka-shi (JP); Junya TAKAHASHI, Tokyo (JP); Yuki AKIYAMA, Tokyo (JP)

(21) Appl. No.: 16/615,693

(22) PCT Filed: Jun. 4, 2018
(86) PCT No.: PCT/JP2018/021311

§ 371 Date: Nov. 21, 2019

(30) Foreign Application Priority Data
Jun. 15, 2017 (JP) 2017-117342

(51) Int. Cl. G05D 1/00; B60W 50/08; B60W 30/09; B60W 40/08; G05D 1/02

(52) U.S. Cl. CPC G05D 1/0061; B60W 50/08; G05D 1/021; B60W 40/08; B60W 30/09

(57) ABSTRACT

The present invention provides a travel control device for a vehicle with which it is possible to control the vehicle so that, by appropriately controlling override in accordance with the vehicle behavior upon driver override, the vehicle behavior does not become unstable. This travel control device comprises: a vehicle control plan creation unit that creates a control plan for a vehicle; an operation detail acquisition unit that acquires operation details by a driver to the vehicle; a vehicle control assessment unit that determines vehicle control details on the basis of the control plan and the driver's operation details; a vehicle behavior assessment unit that assesses the behavior of the vehicle; and a vehicle control detail determination unit that determines whether or not to prioritize the driver's operation details over the vehicle control plan on the basis of the behavior of the vehicle as assessed by the vehicle behavior assessment unit.

### TECHNICAL FIELD

The present invention relates to a travel control device.

### BACKGROUND ART

Development of an advanced driving assistant system (ADAS) and technologies related to automated driving in automobiles has been rapidly advanced in recent years. Adaptive cruise control, a lane keeping assist system, emergency automatic braking, and the like have come into practical use as functions to automate some driving operation.

All of these functions are systems that allow operation intervention by a driver (override) during control. Regarding vehicle control when the override is performed, PTL 1 discloses an automatic operation vehicle control device for controlling an automatic operation vehicle that switches from automatic operation to manual operation when the driver overrides. Further, PTL 2 discloses a vehicle control device that corrects a target vehicle behavior based on a driver override.

### CITATION LIST

### Patent Literature

PTL 1: JP 2012-051441 A

PTL 2: WO 2014/115262 A

### SUMMARY OF INVENTION

### Technical Problem

In recent years, many traffic accidents have occurred due to misoperations of elderly people and drivers who are unfamiliar with driving, and there is a need for rapid development of automated driving.

Whereas, since driver's attention and concentration on driving during traveling is considered to decrease as automated driving becomes more advanced (the automated driving level becomes higher), there is a possibility that a driver's action of operation intervention becomes a big movement in a sudden situation, and the vehicle behavior becomes unstable depending on the driving situation.

As a current concept of automated driving, a driver override has priority in all, and either the override or trajectory control with automated driving is selected depending on a stability degree of a vehicle behavior. Further, it is not implemented to control the intervention of the override itself in accordance with a state of the vehicle behavior at the time of the override.

Accordingly, an object of the present invention is to provide a travel control device for a vehicle with which it is possible to control the vehicle so that, by appropriately controlling an override in accordance with the vehicle behavior upon a driver override, the vehicle behavior does not become unstable.

### Solution to Problem

In order to solve the above problem, a travel control device according to the present invention has a configuration including: a vehicle control plan creation unit that creates a control plan for a vehicle; an operation detail acquisition unit that acquires operation details by a driver to the vehicle; a vehicle control assessment unit that determines vehicle control details on the basis of the control plan and the driver's operation details; a vehicle behavior assessment unit that assesses the behavior of the vehicle; and a vehicle control detail determination unit that determines whether or not to prioritize the driver's operation details over the vehicle control plan on the basis of the behavior of the vehicle as assessed by the vehicle behavior assessment unit.

### Advantageous Effects of Invention

According to the present invention, it is possible to provide a travel control device for a vehicle with which it is possible to control the vehicle so that, by appropriately controlling an override in accordance with the vehicle behavior upon a driver override, the vehicle behavior does not become unstable.

### BRIEF DESCRIPTION OF DRAWINGS

FIG. 1 is a block diagram of a travel control device for a vehicle according to an embodiment of the present invention.

FIG. 2 is a block diagram describing processing of a vehicle control assessment unit according to the embodiment of the present invention.

FIG. 3 is a flowchart describing processing of a vehicle behavior assessment unit according to the embodiment of the present invention.

FIG. 4 is a flowchart representing processing of steering operation propriety signal generation means based on a vehicle behavior in a lateral direction of the vehicle, by the vehicle behavior assessment unit according to the embodiment of the present invention.

FIG. 5 is a graph representing an example of a vehicle behavior assessment process in the lateral direction of the vehicle, by the vehicle behavior assessment unit according to the embodiment of the present invention.

FIG. 6 is a flowchart representing processing of brake/accelerator operation propriety signal generation means based on a vehicle behavior in a longitudinal direction of the vehicle, by the vehicle behavior assessment unit according to the embodiment of the present invention.

FIG. 7 is a graph representing an example of a vehicle behavior assessment process in the longitudinal direction of the vehicle, by the vehicle behavior assessment unit according to the embodiment of the present invention.

FIG. 8 is a flowchart describing processing of a vehicle control detail determination unit according to the embodiment of the present invention.

FIG. 9 is a flowchart describing processing of a vehicle control plan correction unit according to the embodiment of the present invention.

FIG. 10 is a view representing a scene of passing on an ice burn while traveling on a curved road, as Example 1 of the present invention.

FIG. 11 is a graph representing an example of a steering angle and a yaw rate in Example 1 of the present invention.

FIG. 12 is a view representing a scene of avoiding a collision with an obstacle jumping out, while traveling on a curved road, as Example 2 of the present invention.

FIG. 13 is a graph representing an example of a steering angle and a yaw rate in Example 2 of the present invention.

FIG. 14 is a view representing an example of a situation where there is danger to a surrounding environment due to a driver's misoperation, in Example 3 of the present invention.

FIG. 15 is a block diagram describing processing of a vehicle control assessment unit according to an embodiment of Example 3 of the present invention.

FIG. 16 is a flowchart including and describing detailed processing of a surrounding environment risk determination unit in processing of the vehicle control assessment unit according to the embodiment of Example 3 of the present invention.

### DESCRIPTION OF EMBODIMENTS

Hereinafter, an embodiment of a travel control device for a vehicle of the present invention will be described with reference to the drawings.

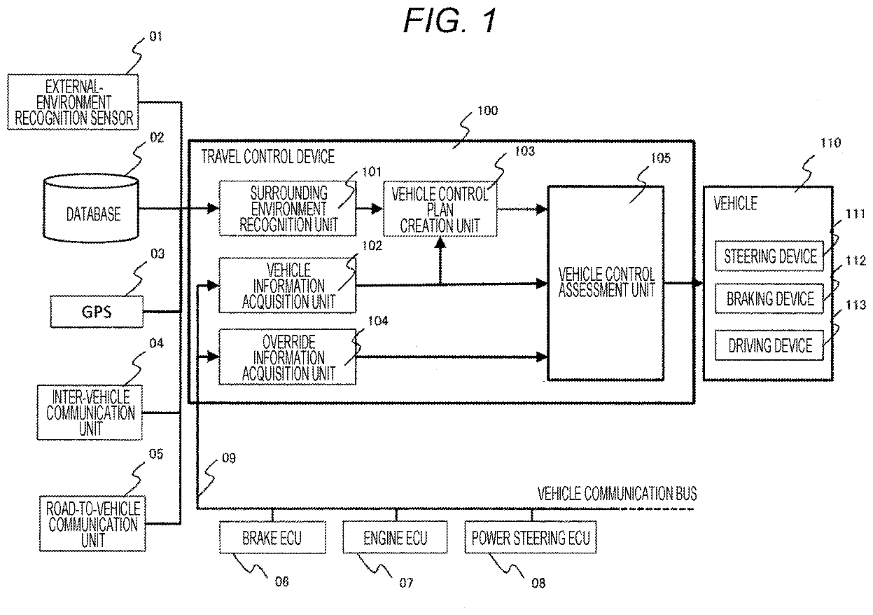

FIG. 1 is a block diagram of a travel control device for a vehicle according to the present embodiment. In FIG. 1, a travel control device 100 includes a surrounding environment recognition unit 101, a vehicle information acquisition unit 102, a vehicle control plan creation unit 103, an override information acquisition unit 104, and a vehicle control assessment unit 105.

A vehicle 110 has a steering device 111, a braking device 112, and a driving device 113. In accordance with a control command value calculated by the travel control device 100, the steering device 111 controls steering of the vehicle, the braking device 112 controls braking of the vehicle, and the driving device 113 controls driving of the vehicle.

The surrounding environment recognition unit 101 has functions of: acquiring information such as recognition information of obstacles and lanes around the own vehicle from an external-environment recognition sensor 01, road shape information from a database 02, information on an own vehicle position, an own vehicle speed, an own vehicle direction, and the like from a global positioning system (GPS) 03, an inter-vehicle communication unit 04, and a road-to-vehicle communication unit 05, and information on a relative position, a relative speed, and the like with other traffic participants; grasping a surrounding environment of the own vehicle for determining an own vehicle traveling direction; and transmitting to the vehicle control plan creation unit 103.

Note that the external-environment recognition sensor 01 is preferably configured by a sensor capable of recognizing obstacles, lanes, signals, and the like around the own vehicle, such as a stereo camera, a millimeter wave radar, a laser radar, and an infrared sensor.

The vehicle information acquisition unit 102 has functions of: collecting vehicle behavior information such as an own vehicle speed (wheel speed), a yaw rate, longitudinal acceleration, and lateral acceleration from ECUs equipped with a sensor, such as a brake ECU 06, an engine ECU 07, and a power steering ECU 08; and transmitting to the vehicle control plan creation unit 103 and the vehicle control assessment unit 105.

The vehicle control plan creation unit 103 has functions of: generating a traveling trajectory of the own vehicle on the basis of information from the surrounding environment recognition unit 101 and the vehicle information acquisition unit 102; and transmitting to the vehicle control assessment unit 105.

The override information acquisition unit 104 has functions of: collecting driver operation information such as an accelerator operation amount, a brake operation amount, and a steering operation amount from ECUs equipped with a sensor, such as the brake ECU 06, the engine ECU 07, and the power steering ECU 08; and transmitting to the vehicle control assessment unit 105.

However, in the present embodiment, a vehicle communication bus 09 performs transmission and reception using a controller area network (CAN), which is generally used as an in-vehicle network.

The vehicle control assessment unit 105 has functions of: calculating a steering command value, a brake command value, and a drive command value on the basis of information of the vehicle information acquisition unit 102, the vehicle control plan creation unit 103, and the override information acquisition unit 104; and transmitting respective command values to the steering device 111, the braking device 112, and the driving device 113 provided in the vehicle 110.

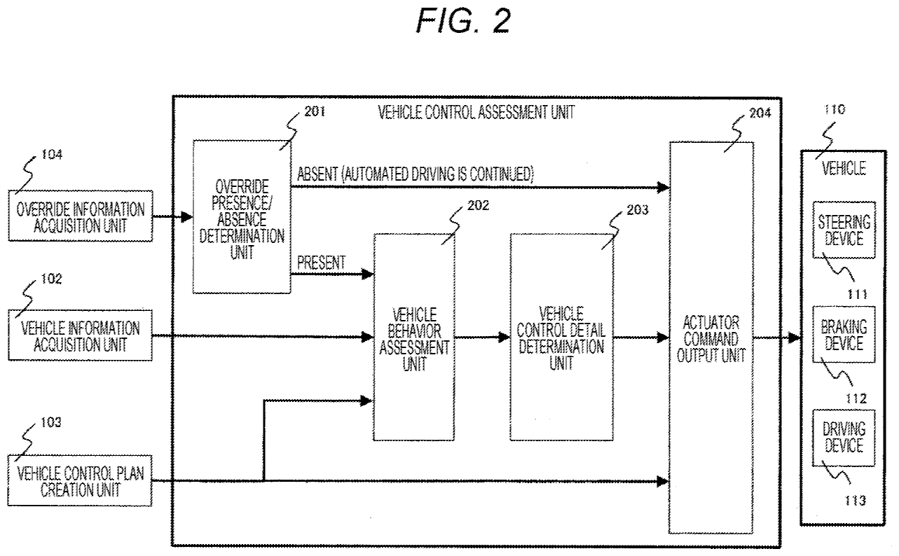

Moreover, the vehicle control assessment unit 105 is configured by a read only memory (ROM) to store a travel control algorithm, a central processing unit (CPU) that executes various arithmetic processes, a random access memory (RAM) to store calculation results, and the like. A detailed internal configuration of the vehicle control assessment unit 105 will be described below with reference to FIG. 2.

The steering device 111 is preferably configured to control a steering angle with hydraulic power steering, electric power steering, or the like on the basis of a steering command value from the vehicle control assessment unit 105.

The braking device 112 is preferably configured to control a braking force with a hydraulic brake, an electric brake, or the like on the basis of a brake command value from the vehicle control assessment unit 105.

The driving device 113 is preferably configured by: an engine that can control engine torque with an electric throttle and the like on the basis of a drive command value from the vehicle control assessment unit 105; a power train system that can control a driving force in response to a drive command from outside with a motor; and the like.

Note that, in the present embodiment, the travel control device 100, the steering device 111, the braking device 112, and the driving device 113 are described as separate devices. However, for example, it is also possible to combine the travel control device 100 for a vehicle and each device (the steering device 111, the braking device 112, and the driving device 113) into one device, or combine only the travel control device 100 for a vehicle and the steering device 111 (or may be the braking device 112 or the driving device 113) into one device.

Further, in the present embodiment, in information transmission between the vehicle control assessment unit 105 and the vehicle, transmission and reception are performed using CAN, which is generally used as an in-vehicle network.

Next, an internal configuration of the vehicle control assessment unit 105 will be described.

1 FIG. 2 is an internal block diagram of the vehicle control assessment unit 105. Note that, in FIG. 2, illustration of the CPU, the RAM, and the like is omitted.

First, an override presence/absence determination unit 201 determines the presence or absence of a driver override on the basis of a driver operation amount acquired by the override information acquisition unit 104.

When the driver override is determined to be “absent” in the override presence/absence determination unit 201, the steering device 111, the braking device 112, and the driving device 113 provided in the vehicle 110 are controlled in accordance with a steering command, a brake command, and a drive command that are set and outputted by an actuator command output unit 204 to achieve traveling according to a trajectory as it is (without correction) created by the vehicle control plan creation unit 103.

When the driver override is determined to be “present” in the override presence/absence determination unit 201, control command values to the steering device 111, the braking device 112, and the driving device 113 provided in the vehicle 110 are corrected by a vehicle behavior assessment unit 202 and a vehicle control detail determination unit 203, and outputted from the actuator command output unit 204.

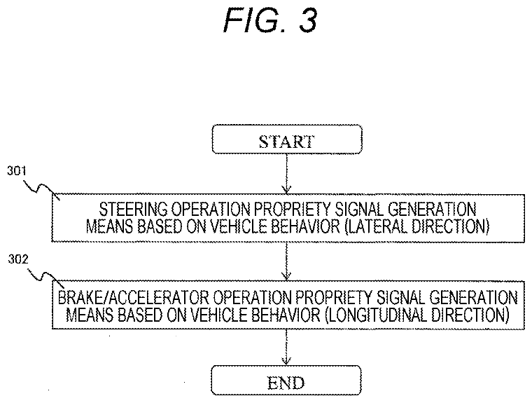

Internal processing of the vehicle behavior assessment unit 202 is shown in FIG. 3.

The vehicle behavior assessment unit 202 assesses a vehicle behavior state and determines whether or not intervention of each operation is possible, by performing a process (301) of generating a steering operation propriety signal on the basis of a vehicle behavior in a lateral direction of the vehicle, and a process (302) of generating a brake/accelerator operation propriety signal on the basis of a vehicle behavior in a longitudinal direction of the vehicle.

Table 1 shows output signals as a result of determination by the vehicle behavior assessment unit 202.

TABLE 1
Output signal

| | | Steering operation | Brake/accelerator |
|---|---|---|---|
| | Vehicle status | propriety | operation propriety |
| 1 | Stable | Possible | Possible |
| 2 | Unstable | Possible | Impossible |
| 3 | Unstable | Impossible | Possible |
| 4 | Unstable | Impossible | Impossible |

As shown in Table 1, the vehicle behavior detection unit 202 outputs a vehicle status signal, a steering operation propriety signal, and a brake/accelerator operation propriety signal. Here, “stable” of the vehicle behavior state in the present invention is a state where the vehicle behavior is not disturbed by the driver override, while “unstable” is a state where the vehicle behavior may be disturbed by the driver override, or the vehicle behavior is already disturbed.

The vehicle status signal in Table 1 is determined with a vehicle behavior assessment result in steering operation propriety signal generation means 301 based on a vehicle behavior (lateral direction) and with brake/accelerator operation propriety signal generation means 302 based on a vehicle behavior (longitudinal direction).

For the steering operation propriety signal, propriety is determined on the basis of a vehicle behavior assessment result of the steering operation propriety signal generation means 301 based on a vehicle behavior (lateral direction).

For the brake/accelerator operation propriety signal, propriety is determined on the basis of a vehicle behavior assessment result of the brake/accelerator operation propriety operation propriety signal generation means 302 based on a vehicle behavior (longitudinal direction).

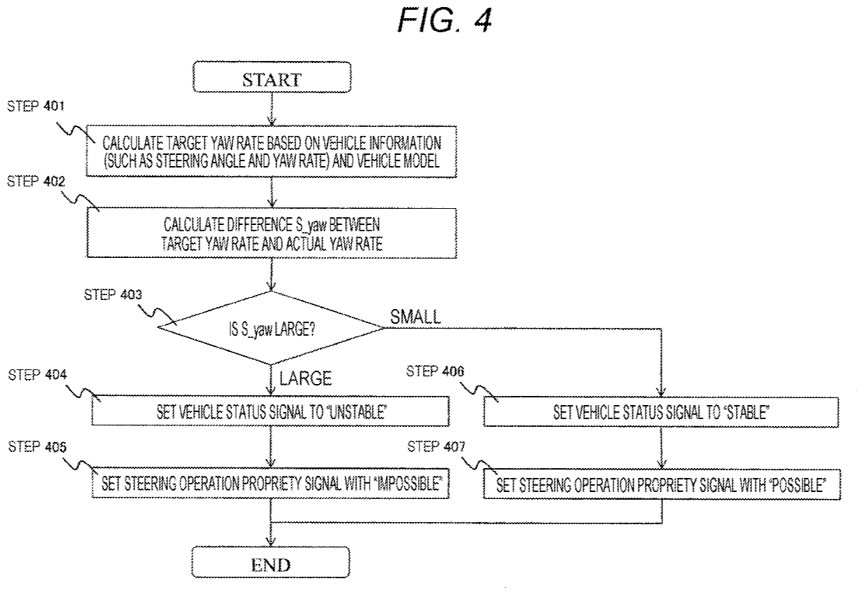

FIG. 4 is one Example of the steering operation propriety signal generation means 301 based on a vehicle behavior (lateral direction).

First, in step 401, a target yaw rate is calculated on the basis of lateral movement information of the vehicle (a steering speed, a yaw rate, lateral acceleration, lateral jerk, and the like) obtained from the vehicle information acquisition unit 102, and on the basis of a general vehicle model.

Next, in step 402, a difference S_yaw between the target yaw rate and an actual yaw rate is calculated.

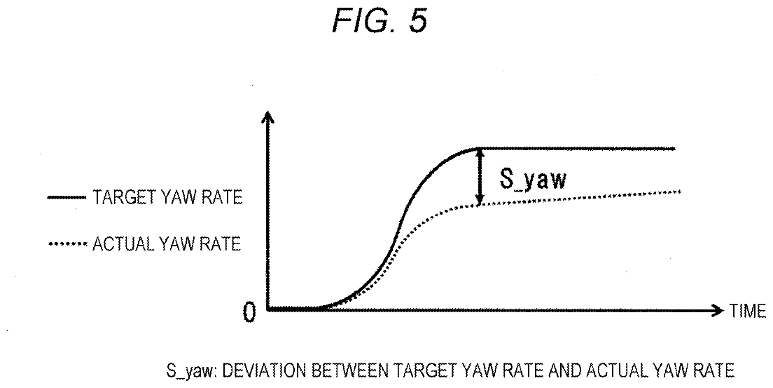

Here, FIG. 5 shows an example representing a state of deviation between the target yaw rate and the actual yaw rate.

In step 403, processing is branched depending on magnitude of the difference S_yaw calculated in step 402 between the target yaw rate and the actual yaw rate. Here, a threshold value for the branch determination may be a fixed value as determined with a vehicle type, or may be dynamically switched in accordance with vehicle status or a traveling scene.

In step 403, when the difference S_yaw between the target yaw rate and the actual yaw rate is large (any given threshold value or more), the vehicle behavior in the lateral direction of the vehicle is considered to be in an unstable state, the vehicle status signal is set to “unstable” (step 404), and the steering operation propriety signal is set to “impossible” (step 405). The reason for setting the vehicle status signal to “unstable” and the steering operation propriety signal to “impossible” is to prevent a situation in which the vehicle behavior further diverges due to addition of the driver override, because the vehicle behavior may become “unstable” in the future since the vehicle's yaw response is delayed with respect to the steering command.

Whereas, when the difference S_yaw between the target yaw rate and the actual yaw rate is small (any given threshold value or less) in step 403, it is determined that the vehicle behavior is not disturbed even if a driver override is performed at that time, and the vehicle status signal is set to “stable” (step 406), and the steering operation propriety signal is set to “possible” (step 407), since the vehicle yaw is in a state of responding to the steering command.

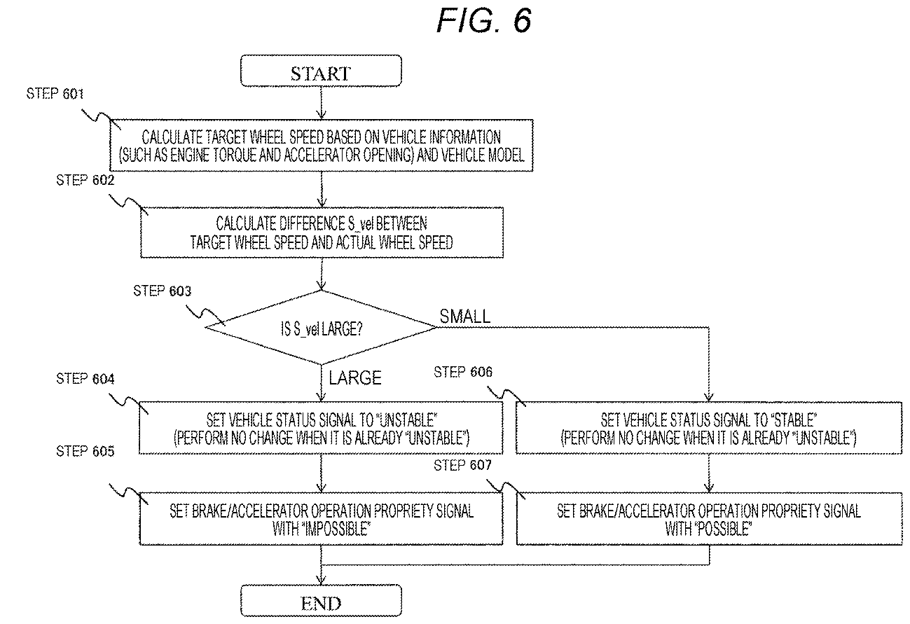

FIG. 6 is an Example of the brake/accelerator operation propriety signal generation means 302 based on a vehicle behavior (longitudinal direction).

First, in step 601, a target wheel speed is calculated on the basis of longitudinal movement information of the vehicle (engine torque, accelerator opening, a wheel speed, longitudinal acceleration, and the like) obtained from the vehicle information acquisition unit 102, and on the basis of a general vehicle model.

Next, in step 602, a difference S_vel between the target wheel speed and an actual wheel speed is calculated.

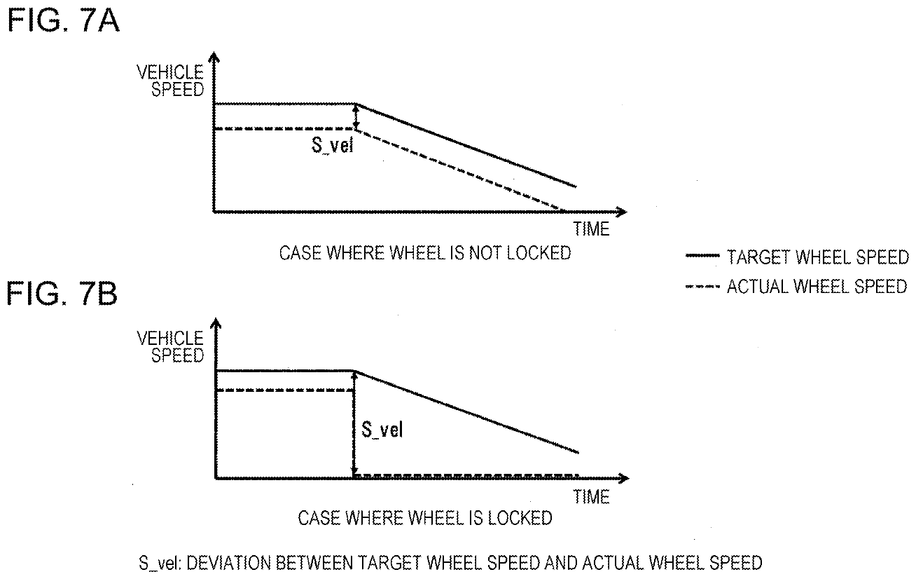

Here, FIG. 7 shows an example representing a state of deviation between the target wheel speed and the actual wheel speed when a wheel is not locked (FIG. 7(a)) and locked (FIG. 7(b)).

In step 603, processing is branched depending on magnitude of the difference S_vel calculated in step 602 between the target wheel speed and the actual wheel speed. Here, a threshold value for the branch determination may be a fixed value as determined with a vehicle type, or may be dynamically switched in accordance with vehicle status or a traveling scene.

In step 603, when the difference S_vel between the target wheel speed and the actual wheel speed is large (any given threshold value or more), the vehicle behavior in the longitudinal direction of the vehicle is considered to be in an unstable state, the vehicle status signal is set to “unstable” (step 604), and the brake/accelerator operation propriety signal is set to “impossible” (step 605). The reason for setting the vehicle status signal to “unstable” and the brake/accelerator operation propriety signal to “impossible” is to prevent a situation in which the vehicle behavior is further disturbed due to addition of the driver override, because the behavior in the longitudinal direction of the vehicle may become “unstable” in the future, that is, acceleration/deceleration control may not be possible, since the actual wheel speed suddenly deviates from the target wheel speed as shown in FIG. 7(b). For example, performing a strong brake/accelerator operation by automated driving or by the driver during traveling on a road surface with a low road surface friction coefficient μ (ice burn, and the like) causes a state where the wheels are locked and the vehicle continues to slide and move, and it can be said that the vehicle behavior in the longitudinal direction of the vehicle is unstable.

Whereas, when the difference S_vel between the target wheel speed and the actual wheel speed is small (any given threshold value or less) in step 603, it is determined that the vehicle behavior is not disturbed even if a driver override is performed at that time, and the vehicle status signal is set to “stable” (step 606), and the brake/accelerator operation propriety signal is set to “possible” (step 607) since each wheel is in a state of being normally driven in accordance with an acceleration/deceleration command.

Here, in a case of using a vehicle behavior assessment method using a wheel speed, the wheel speed may be measured with a wheel to which a braking/driving force is transmitted. In addition, the measurement of the wheel speed may be performed with only one wheel, or may be performed with two to four wheels.

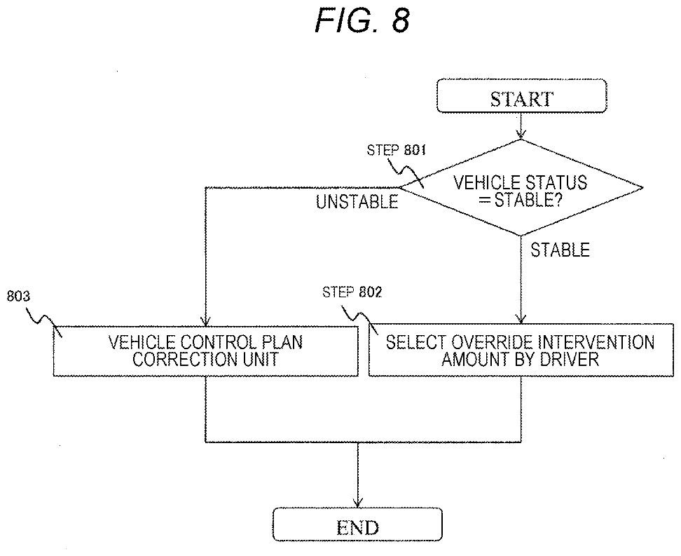

FIG. 8 is a flowchart showing a process flow of the vehicle control detail determination unit 203.

First, in step 801 (vehicle status determination unit), subsequent processing is branched depending on whether a vehicle status signal outputted from the vehicle behavior assessment unit 202 is “stable” or “unstable”.

When the vehicle status is “stable” in the step 801, a driver override is permitted, and an operation intervention amount by the driver is selected (step 802).

When the vehicle status is “unstable” in step 801, in a vehicle control plan correction unit 803, a control amount of a vehicle control plan is corrected on the basis of details of a steering operation propriety signal and a brake/accelerator operation propriety signal determined by the vehicle behavior assessment unit 202.

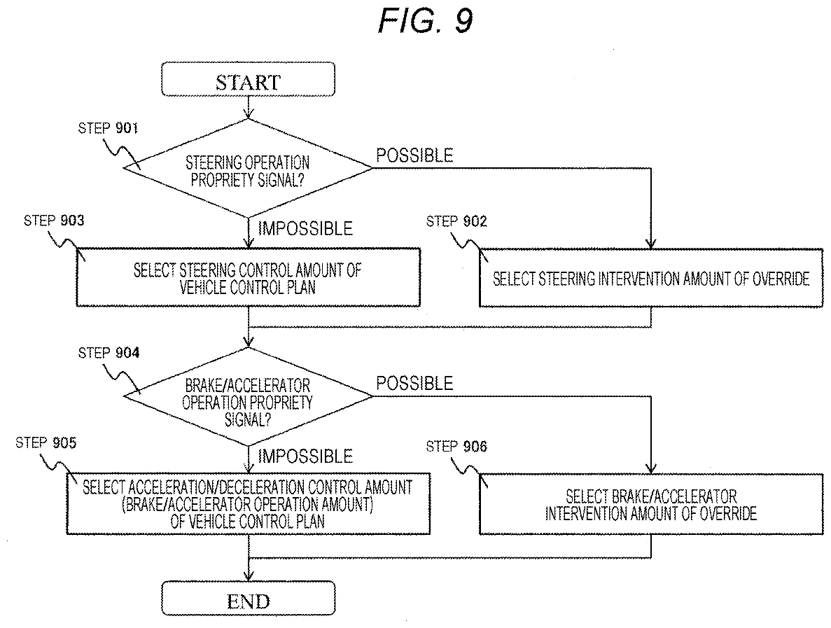

FIG. 9 is a flowchart showing a process flow of the vehicle control plan correction unit 803.

In step 901 and step 904(these steps are collectively referred to as an intervention possible operation presence/absence determination unit), the presence or absence of an operation allowed to intervene is determined with the steering operation propriety signal and the brake/accelerator operation propriety signal outputted from the vehicle behavior assessment unit 202.

When it is determined in step 901 that the steering propriety signal is “possible”, in step 902, an intervention amount of the override is selected as a control amount of the vehicle control plan, and is selected as an output command to the steering device.

Whereas, when it is determined in step 901 as “impossible”, the driver override is not selected in step 903, and a control amount of the original vehicle control plan is selected as it is as an output command to the steering device.

When it is determined in step 904 that the steering propriety signal is “possible”, in step 906, an intervention amount of the override is selected as a control amount of the vehicle control plan, and is selected as an output command to the braking device/driving device.

Whereas, when it is determined in step 904 as “impossible”, the driver override is not selected in step 905, and a control amount of the original vehicle control plan is selected as it is as an output command to the braking device/driving device.

Examples using the above-described embodiment of the present invention will be described below.

(Example 1 of Travel Control Device)

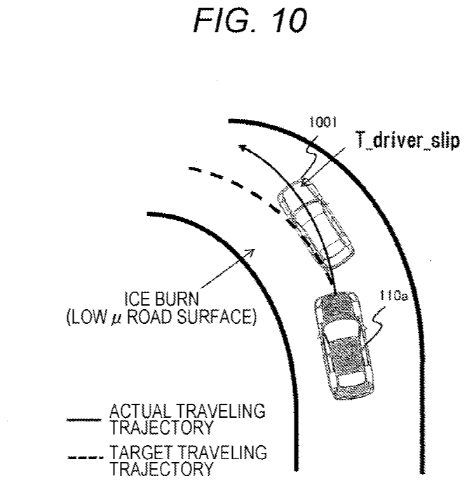

As Example 1, FIG. 10 illustrates a scene where a vehicle 110a in automated driving passes on an ice burn (low p road surface) while traveling on a curved road.

Specifically, a case is assumed where, as a result of traveling on the ice burn (low μ road surface), the vehicle 110a in automated driving has an actual traveling trajectory (solid line in FIG. 10) with an understeer tendency with respect to a target traveling trajectory (broken line in FIG. 10) calculated by the vehicle control plan creation unit 103 on the basis of curve curvature information obtained from the surrounding environment recognition unit 101.

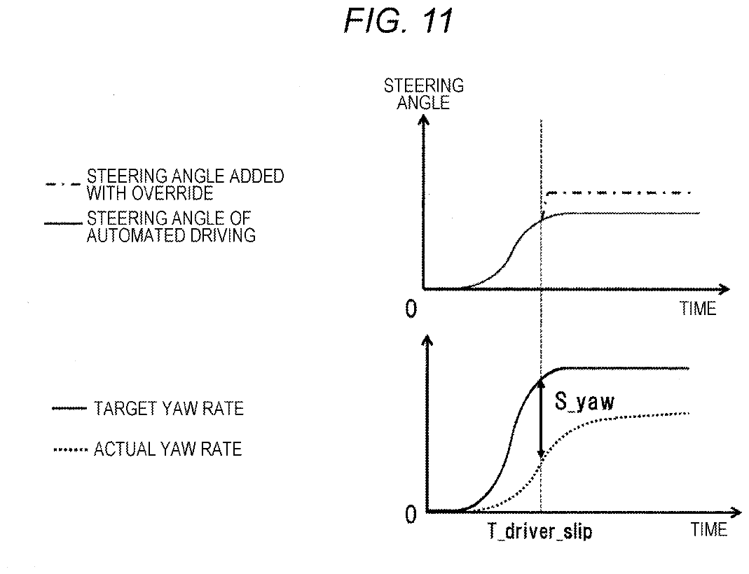

FIG. 11 is a graph showing steering angles and yaw rates in time series when the vehicle 110a in automated driving shown in FIG. 10 travels on a curved road. Note that an origin is timing to start steering.

At a time point of timing T_driver_slip shown in FIG. 11, the driver feels that a traveling route of the vehicle 110a in automated driving has an understeer tendency, and the driver further increases steering to perform override. At this time, the override information acquisition unit 104 acquires the override by steering.

Then, in the vehicle control assessment unit 105, since the override presence/absence determination unit 201 determines that the override is “present” from the result of the override information acquisition unit 104, the vehicle behavior assessment unit 202 determines a state of a vehicle behavior at the time when the override is performed.

It is assumed that an actual yaw rate (broken line in FIG. 11) as shown in FIG. 11 has occurred in the vehicle 110a. Focusing on the yaw rate at the timing T_driver_slip when the driver has performed the override, the difference S_yaw between the target yaw rate and the actual yaw rate is large. Therefore, if the override by the driver's steering operation is permitted at this point, the vehicle behavior thereafter is expected be greatly disturbed. Consequently, the steering operation propriety signal is set to “impossible”, and the vehicle behavior state signal is to be “unstable”.

In this Example 1, the explanation about the vehicle behavior assessment in the longitudinal direction of the vehicle has not been described. However, in a case of performing an override of a brake operation and an accelerator operation in addition to the steering operation, the brake/accelerator operation propriety signal is determined on the basis of a result of the brake/accelerator operation propriety signal generation means 302 based on a vehicle behavior (longitudinal direction) in the vehicle behavior assessment unit 202.

Next, since the vehicle status signal outputted from the vehicle behavior assessment unit 202 is “unstable” in the vehicle control detail determination unit 203, it is determined whether or not the override by the steering operation is to be considered by the processing of the vehicle control plan correction unit 603. In the case of Example 1, since the steering operation propriety signal is set to “impossible”, the override by the driver's steering operation is not accepted, and a steering control amount based on the original vehicle control plan is outputted.

(Example 2 of Travel Control Device)

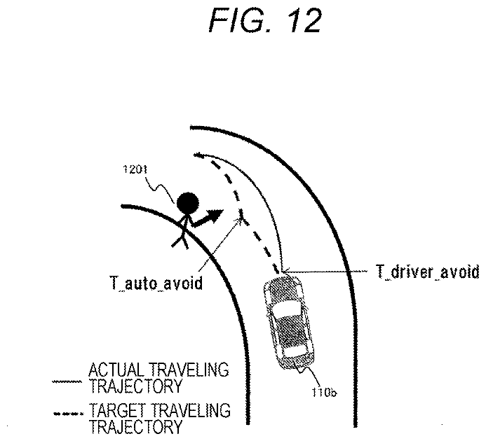

As Example 2, a scene of emergency avoidance shown in FIG. 12 will be described.

FIG. 12 shows a scene in which an obstacle 1201 suddenly jumps out toward a roadway while a vehicle 110b in automated driving is traveling on a curve on a dry road surface. T_driver_avoid shown in FIG. 12 represents timing when the driver has performed an override, and T_auto_avoid represents timing at which steering avoidance planned by the vehicle control plan creation unit 103 in the automated driving has been scheduled to start.

Specifically, an Example is described in a scene where, while the vehicle 110b in automated driving travels on a curved road with respect to a target traveling trajectory calculated by the vehicle control plan creation unit 103 (broken line in FIG. 12) on the basis of curve curvature information obtained from the surrounding environment recognition unit 101, the obstacle 1201 (a pedestrian, a bicycle, a motorcycle, and the like) suddenly jumps out toward the target trajectory of the vehicle 110b, and the vehicle 110b in automated driving plans a travel to avoid the obstacle by correcting the target trajectory at the timing T_auto_avoid shown in FIG. 12. However, in the scene, the driver cannot wait for the collision avoidance by the automated driving with the vehicle control plan, and collision avoidance is started by own steering operation or brake operation at the timing T_driver_avoid shown in FIG. 12.

In the surrounding environment recognition unit 101, the external-environment recognition sensor 01 always monitors the presence or absence of obstacles in a traveling direction in addition to a road shape in the traveling direction, and also detects a size and movement (a moving speed, moving direction) of the obstacle 1201 if the obstacle 1201 appears in the middle of the curve. In accordance with the size and movement of the obstacle 1201, the vehicle control plan creation unit 103 calculates an avoidance route.

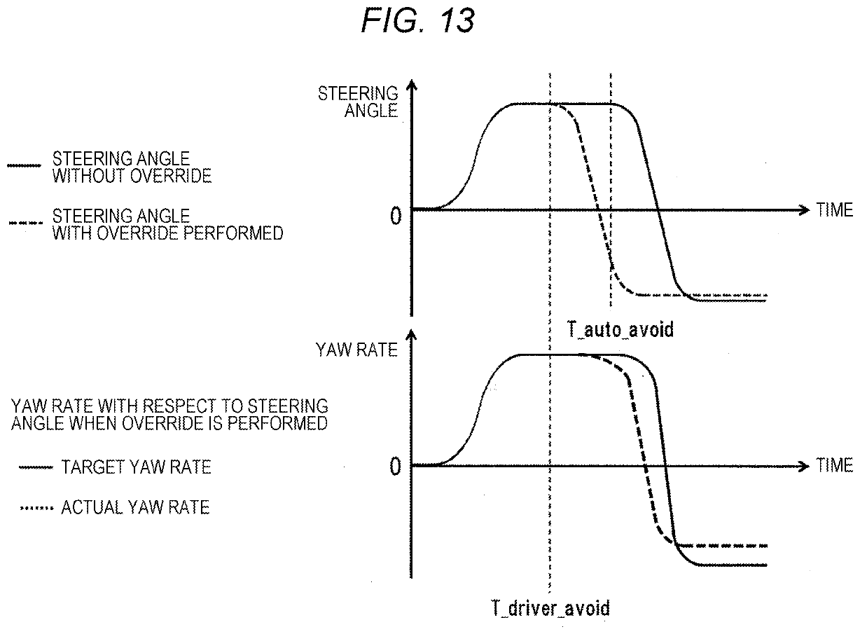

FIG. 13 is a graph showing steering angles and yaw rates of the vehicle 110b in the Example of FIG. 12 in time series. Note that an origin is timing to start steering. Further, the graph of the steering angle shows a steering angle scheduled to be implemented in the vehicle control plan in a case if the override by the driver's steering operation has been desired to be performed.

At a time point of the timing T_driver_avoid shown in FIG. 13, the driver senses a risk of colliding with the obstacle 1201 that has jumped out, and the driver starts collision avoidance by own steering operation or brake operation. At this time, the override information acquisition unit 104 acquires the override by the steering operation and the brake operation.

Then, in the vehicle control assessment unit 105, since the override is determined to be “present” as a result of the override presence/absence determination unit 201 on the basis of the override information acquisition unit 104, the vehicle behavior assessment unit 202 determines a vehicle behavior state in the longitudinal and lateral directions of the vehicle at the time when the override is performed.

First, it is assumed that an actual yaw rate (broken line in FIG. 13) as shown in FIG. 13 has been generated in the vehicle 110 as a vehicle behavior state in the lateral direction of the vehicle. Focusing on the yaw rate at the timing T_driver_avoid when the driver has performed the override, the difference S_yaw between the target yaw rate and the actual yaw rate is small. Therefore, the steering operation propriety signal is set to “possible” since the vehicle behavior is not expected to be disturbed even if the override by the driver's steering operation intervenes at this point.

Next, as shown in FIG. 7(a), as a vehicle behavior state in the longitudinal direction of the vehicle, when a brake operation is performed on a dry road, the brake operation propriety signal is “possible” as long as the brake is not applied strongly enough to lock the wheel. Whereas, as shown in FIG. 7(b), when the wheel is locked, the brake operation propriety signal is to be “impossible”. In Example 2, a description will be made while assuming that the brake operation propriety signal is “possible”.

As described above, in Example 2, since both the steering operation propriety signal and the brake operation propriety signal are “possible”, the vehicle behavior state signal is to be “stable”.

Next, since the vehicle status signal outputted from the vehicle behavior assessment unit 202 is “stable” in the vehicle control detail determination unit 203, the driver's steering operation and the brake operation are all permitted, and a control amount added with the driver's intervention amount is outputted to each actuator, in addition to the steering control amount and the brake control amount based on the original vehicle control plan.

Example 1 and Example 2 have described a scene on a curved road. However, the present invention is not limited to a curved road, but is applied to a case where a driver override is performed in various situations such as straight roads and intersections.

(Example 3 of Travel Control Device)

In the configuration of the travel control device described in Example 1 and Example 2 above, when a driver override is performed, propriety of the override is determined on the basis of a state of a vehicle behavior. However, in some cases, a driver override may cause danger to a surrounding environment even if the vehicle behavior state is stable.

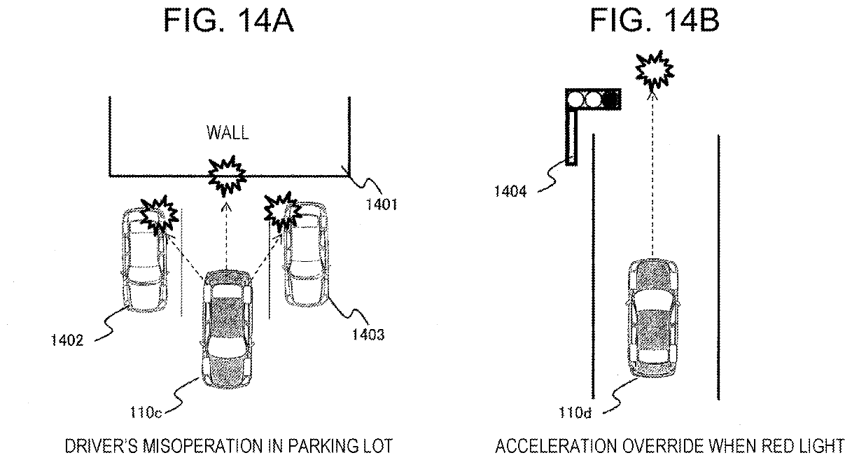

FIG. 14 is a view showing an example of scenes in which an override causes a danger even if the vehicle behavior state is stable.

For example, these are: a situation where, as shown in FIG. 14(a), an erroneous operation (mistake the brake and the accelerator) by the driver of the vehicle 110c in a parking lot does not cause the vehicle behavior to be unstable, but there is a risk of contact or collision with surrounding vehicles 1402 and 1403, a wall 1401, and many pedestrians in a case of a parking lot of a store; and a situation where, as shown in FIG. 14(b), even though a traffic signal 1404 in the traveling direction is red (including signs and signals other than the traffic signal 1404 that instruct the vehicle to stop), the driver of the vehicle 110d steps on the accelerator for an unexpected reason (not aware of the red color, unconscious due to sudden illness, and the like), and then an accident occurs at an intersection, a construction site, a railroad crossing, and the like that will appear ahead.

Therefore, in Example 3, a description is given to a configuration in which propriety determination of the override includes a condition as to whether or not there is a possibility that the override causes danger to the surroundings of the own vehicle.

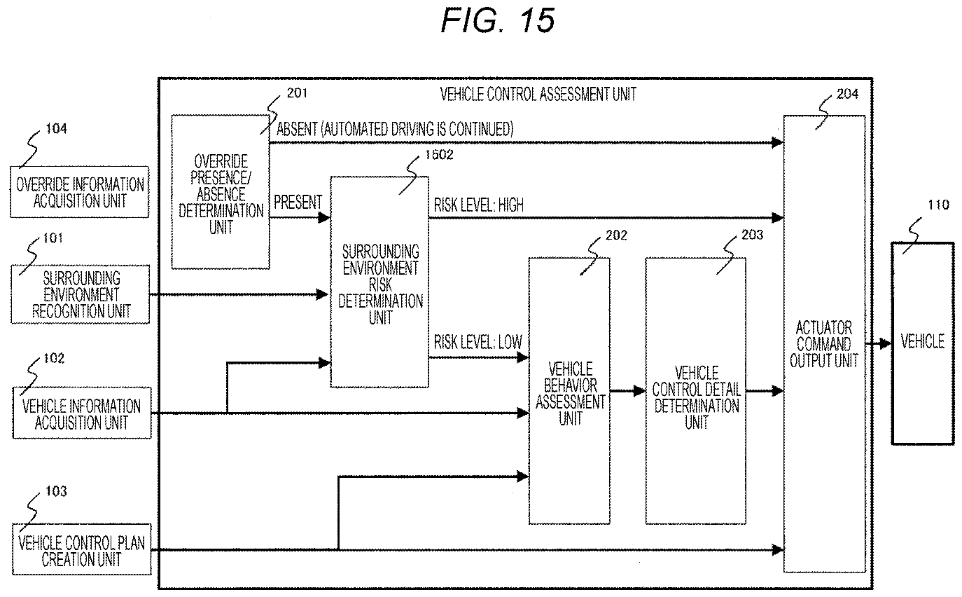

A hardware configuration of the vehicle can be implemented with a configuration similar to that in FIG. 1, but this Example 3 can be realized by configuring an internal processing of the vehicle control assessment unit 105 as shown in FIG. 15.

In FIG. 15, when the override presence/absence determination unit 201 determines that the driver override is “present”, next, a surrounding environment risk determination unit 1502 determines whether or not it is a scene where the vehicle control plan is to be prioritized.

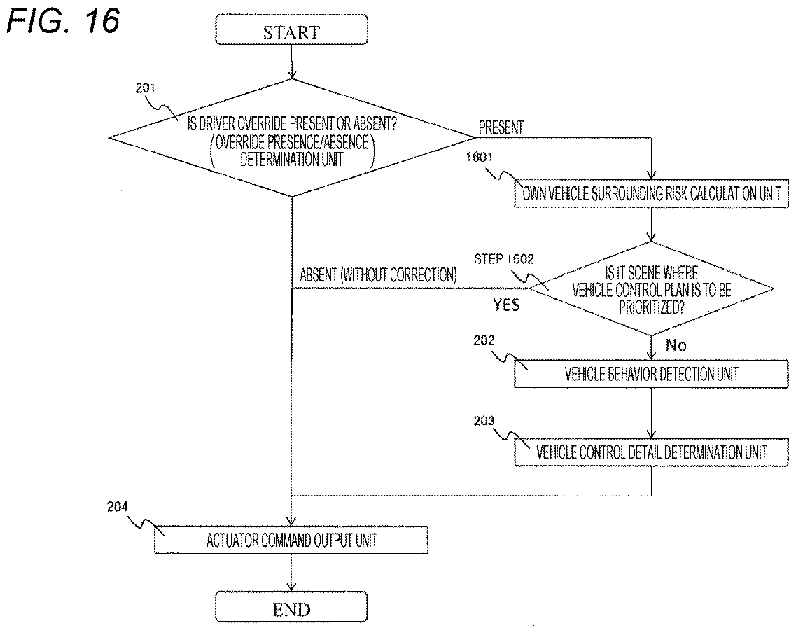

Here, FIG. 16 shows a flowchart illustrating detailed processing of the surrounding environment risk determination unit 1502 in the vehicle control assessment unit in the embodiment of this Example 3.

A risk level around the own vehicle is calculated by an own vehicle surrounding risk calculation unit 1601, and it is determined in step 1602 whether or not it is a scene where the vehicle control plan is to be prioritized.

The own vehicle surrounding risk calculation unit 1601 uses, as an input, information such as surrounding obstacles (a vehicle, a pedestrian, a bicycle, a motorcycle, and the like), traffic lanes, lighting color status of traffic signals, and the presence or absence of intersections, construction sites, railroad crossings, and the like obtained from the surrounding environment recognition unit 101, to calculate a risk level S_d around the own vehicle. Then, it is determined in step 1602 whether or not to prioritize the vehicle control plan on the basis of a result of the calculation.

As an example of the own vehicle surrounding risk calculation by the own vehicle surrounding risk calculation unit 1601, the risk level S_d is set to “high” for an area with obstacles observed by an external environment recognition device, while the risk level S_d is set to “low” for an area with no obstacle in an observable area of the external environment recognition device. In addition, the risk level S_d of an area that cannot be observed in a blind spot of an obstacle or the like is set to “middle”.

In addition, in order to determine the driver override as a misoperation by the driver, a course of the vehicle is predicted from each driver's operation amount acquired by the override information acquisition unit 104 and vehicle information (a vehicle speed, a steering angle, a yaw rate, and the like). When the predicted route passes through a dangerous area (the risk level S_d is a threshold value Th_d or more), the operation (override) by the driver is determined as a misoperation, and it is determined in step 1602 as a scene where the vehicle control plan is to be prioritized.

Here, the threshold value Th_d can be optionally set. For example, Th_d may be fixedly set to “high”, or Th_d may be set to be variably changed in accordance with a time zone (such as commuting time for work and school) or a traveling scene.

When it is determined in step 1602 that the vehicle control plan is to be prioritized, a target trajectory calculated by the vehicle control plan creation unit 103, and control commands for a steering, an accelerator, a brake, and the like for the target trajectory are outputted without correction.

Subsequent processing when it is determined in step 1602 that the vehicle control plan is not to be prioritized will not be described because processing similar to that described in Example 1 and Example 2 is performed.

As described above, a description has been given with a configuration in which, when the driver performs operation intervention during automated driving, propriety of the operation intervention by the driver is determined depending on a vehicle behavior state at that time. However, the present invention is also applied to a vehicle not equipped with automated driving (a vehicle equipped with a driving support system such as adaptive cruise control (ACC) and a lane keeping assist system (LKS)).

In addition, in a case where the operation is not reflected in the vehicle even though an override is performed by the driver of the vehicle equipped with the present invention, uneasiness may be given to the vehicle. Therefore, there may be provided a mechanism to notify the driver of that fact when the vehicle behavior is unstable or the scene does not allow the override in a case where the override is not permitted, by detecting the vehicle behavior and the scene that does not allow the override in advance.

As mentioned above, although the embodiment of the present invention has been described using drawings, a specific configuration is not limited to the embodiment described above. Further, even if there are design changes and the like within the scope of the present invention, they are included in the present invention. For example, the embodiment described above has been illustrated in detail to facilitate description for easy understanding of the present invention, and is not necessarily limited to the embodiment that includes all the configurations. Additionally, a part of a configuration of an embodiment may be replaced with a configuration of another embodiment, and a configuration of an embodiment may be added with a configuration of another embodiment. Moreover, a part of a configuration of each embodiment may be deleted, replaced, or added with another configuration.

Specifically, the above-described vehicle control plan creation unit has been described by taking up automated driving (control of acceleration/deceleration, steering, and the like so as to follow a target traveling trajectory), but the vehicle control plan may be, in addition to this, an adaptive cruise control (ACC), an emergency automatic brake, a lane keeping assist system, or the like, and may be a vehicle control plan combining two or more of these controls.

In addition, each of the above-described configurations, functions, processing parts, and the like may be realized by hardware, for example, by designing part or all of them with an integrated circuit or the like. In addition, each of the above-described configurations, functions, and the like may be realized by software by interpreting and executing a program in which a processor realizes each function. Information such as a program, a table, and a file for realizing each function can be placed in a recording device such as a memory, a hard disk, or a solid state drive (SSD), or in a recording medium such as an IC card, an SD card, or a DVD.

### REFERENCE SIGNS LIST

01 external-environment recognition sensor
02 database
03 GPS (Global Positioning System)
04 inter-vehicle communication unit
05 road-to-vehicle communication unit
06 brake ECU
07 engine ECU
08 steering
09 vehicle communication bus
100 travel control device
101 surrounding environment recognition unit
102 vehicle information acquisition unit
103 vehicle control plan creation unit
104 override information acquisition unit (operation detail acquisition unit)
105 vehicle control assessment unit
110 vehicle (vehicle also provided with automated driving function)
110a vehicle (vehicle also provided with automated driving function)
110b vehicle (vehicle also provided with automated driving function)
110c vehicle (vehicle also provided with automated driving function)
110d vehicle (vehicle also provided with automated driving function)
111 steering device
112 braking device
113 driving device
202 vehicle behavior assessment unit
203 vehicle control detail determination unit
204 own vehicle surrounding risk calculation unit
803 vehicle control plan correction unit
1001 vehicle 110a having slipped with respect to target trajectory
1201 jumping out obstacle (pedestrian)
1401 wall
1402 parked vehicle
1403 parked vehicle
1404 traffic signal

1. A travel control device comprising:
a vehicle control plan creation unit that creates control plan of a vehicle;
an operation detail acquisition unit that acquires a driver's operation detail to the vehicle;
a vehicle control assessment unit that determines a vehicle control detail based on the control plan and the driver's operation detail;
a vehicle behavior assessment unit that assesses a behavior of the vehicle; and
a vehicle control detail determination unit that determines whether or not to prioritize the driver's operation detail over the control plan of the vehicle based on a behavior of the vehicle as assessed by the vehicle behavior assessment unit.

2. The travel control device according to claim 1, wherein the vehicle behavior assessment unit determines a longitudinal movement and a lateral movement with respect to the vehicle.

3. The travel control device according to claim 1, wherein the vehicle control detail determination unit includes a vehicle control plan correction unit that corrects the control plan of the vehicle when the driver's operation detail is prioritized over the control plan of the vehicle.

4. The travel control device according to claim 3, wherein the vehicle control detail determination unit includes a vehicle status determination unit that determines whether vehicle status is a stable state or an unstable state based on a behavior of the vehicle as assessed by the vehicle behavior assessment unit, and determines whether to correct the control plan or set to the driver's operation detail, based on the vehicle status.

5. The travel control device according to claim 1, wherein when the driver's operation detail is detected and a behavior of the vehicle becomes an unstable state, the vehicle control detail is determined in accordance with a control plan of the vehicle generated by the vehicle control plan creation unit.

6. The travel control device according to 4 claim 1, wherein when the driver's operation detail is detected and a behavior of the vehicle is stable, the vehicle control detail is determined in accordance with the driver's operation detail.

7. The travel control device according to claim 3, wherein
the vehicle control plan correction unit
comprises an intervention possible operation presence/absence determination unit that determines presence or absence of an operation allowed to intervene, based on a behavior of the vehicle as assessed by the vehicle behavior assessment unit,
corrects the control plan of the vehicle when the operation allowed to intervene is possible, and
outputs the control plan of the vehicle when the operation allowed to intervene is impossible.

8. The travel control device according to claim 1, further comprising:
a surrounding environment risk determination unit that determines a risk level based on at least one of an acquired external environment information and the driver's operation detail, wherein
the vehicle control detail determination unit determines Whether or not to prioritize the driver's operation detail over the control plan of the vehicle, based on a behavior of the vehicle and the risk level..

9. The travel control device according to claim 8, wherein the vehicle control detail determination unit prioritizes the control plan of the vehicle when the risk level is higher than a predetermined value.
